(19) United States
(12) Patent Application Publication
(10) Pub. No.: US 2026/0127869 A1
(43) Pub. Date: May 7, 2026

(54) TIME-CONTINUOUS RECURRENT NEURAL NETWORKS FOR COMPUTER VISION

(71) Applicant: QUALCOMM Incorporated, San Diego, CA (US)

(72) Inventors: Per Albert Siden, Linköping (SE); Per Cronvall, Linköping (SE); Gustav Nils Ture Persson, Ljungsbro (SE); Meysam Sadeghigooghari, Linköping (SE); Jacob Roll, Linköping (SE)

(21) Appl. No.: 18/936,738

(22) Filed: Nov. 4, 2024

(51) Int. Cl. G06V 10/82; G06N 3/044; G06V 10/77; G06V 10/80; G06V 20/56

(52) U.S. Cl. CPC G06V 10/82; G06N 3/044; G06V 10/7715; G06V 10/806; G06V 20/56

(57) ABSTRACT

An apparatus configured to perform a perception task may generate sensor features from data from one or more sensors. process the sensor features with a time-continuous recurrent neural network (RNN) to produce time-continuous features, and perform the perception task using the time-continuous features. The time-continuous features may be defined by a first feature vector value corresponding to a first observation time of the one or more sensors, a prediction of a steady state feature vector value, and estimated feature vector values between the first feature vector value and the steady state feature vector value, the estimated feature vector values being defined by a function.

### TECHNICAL FIELD

This disclosure relates to computer vision techniques.

### BACKGROUND

Computer vision applications, including applications in automotives, make use of the detection and analysis of three-dimensional (3D) objects. 3D object detection may include the identification and localization of objects in 3D space using sensors like cameras, LiDAR, and radar. Algorithms process this data to recognize and position objects accurately, enhancing real-time situational awareness.

Example computer vision tasks for automotive application include semantic occupancy prediction, semantic segmentation, lane tracking, and 3D object detection. Semantic occupancy prediction involves predicting the presence and category of objects in a 3D space, typically represented as a grid or voxel space, helping to understand the structure and content of the environment. Semantic segmentation is the process of classifying each pixel in an image into predefined categories, enabling more precise identification and localization of different objects and regions within the image. Lane tracking involves identifying and following lane markings in images or video frames, which is important for autonomous driving systems to navigate and stay within traffic lanes accurately. 3D object detection aims to identify and localize objects within a 3D space, providing detailed information about the position, dimensions, and categories of objects in the environment.

### SUMMARY

In general, this disclosure describes techniques for performing perception tasks that may be used in computer vision and automotive use cases. In particular, this disclosure describes techniques for using time-continuous recurrent neural networks (RNNs) when performing a perception task.

Time-continuous RNNs differ from traditional RNNs in that time-continuous RNNs are not limited to observations at fixed-interval timepoints. Rather, time-continuous RNNs may model feature vector dynamics over time. For example, a time-continuous RNN may use an exponential decay function or another function to estimate feature vector values between a start value (e.g., a feature vector value associated with an observation) and a predicted long-term steady state value at a future time. By explicitly accounting for the time between inputs, time-continuous RNNs can update their internal states smoothly across uneven intervals. This allows a time-continuous RNN to more accurately reflect the temporal dependencies in data that might not be regularly spaced, as is often the case with asynchronous sensor inputs. As such, a time-continuous RNN may more accurately represent feature vector values for systems with multiple asynchronous sensor inputs, such as in computer visions systems for automotive that may use multiple camera sensors, as well as other sensors such as LiDAR, radar, sonar, and others. Furthermore, a time-continuous RNN may allow for better training, as the ability to generate gradients from disparate time instances is readily available, thus allowing a time-continuous RNN to be trained using long-term temporal dependencies in the training dataset. Accordingly, the use of time-continuous RNNs as described herein may result in more accurate outputs of various perception tasks, such as semantic segmentation, semantic occupancy prediction, lane tracking, or 3D object detection.

In one example, this disclosure describes an apparatus configured to perform a perception task, the apparatus comprising a memory, and processing circuitry connected to the memory, the processing circuitry configured to generate sensor features from data from one or more sensors, process the sensor features with a time-continuous RNN to produce time-continuous features, and perform the perception task using the time-continuous features.

In another example, this disclosure describes a method for performing a perception task, the method comprising generating sensor features from data from one or more sensors, processing the sensor features with a time-continuous RNN to produce time-continuous features, and performing the perception task using the time-continuous features.

In another example, this disclosure describes a non-transitory computer-readable storage medium storing instructions that, when executed, cause one or more processors of a device configured to perform a perception task to generate sensor features from data from one or more sensors, process the sensor features with a time-continuous RNN to produce time-continuous features, and perform the perception task using the time-continuous features.

In another example, this disclosure describes a device configured to perform a perception task, the device comprising means for generating sensor features from data from one or more sensors, means for processing the sensor features with a time-continuous RNN to produce time-continuous features, and means for performing the perception task using the time-continuous features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure.

FIG. 2 is a conceptual diagram illustrating an example feature vector over time of a traditional RNN.

FIG. 3 is a conceptual diagram illustrating an example feature vector over time of a time-continuous RNN.

FIG. 4 is a block diagram illustrating an example system that may perform the techniques of this disclosure.

FIG. 5 is a block diagram illustrating an example of temporal BEV processing using a time-continuous RNN in accordance with the techniques of this disclosure.

FIG. 6 is a block diagram illustrating another example of temporal BEV processing using a time-continuous RNN in accordance with the techniques of this disclosure.

FIG. 7 is a conceptual diagram illustrating example training processes in accordance with the techniques of this disclosure.

FIG. 8 is a conceptual diagram illustrating example timings of perception tasks in accordance with the techniques of this disclosure.

FIG. 9 is a flowchart illustrating an example process in accordance with the techniques of this disclosure.

### DETAILED DESCRIPTION

Computer vision techniques, including techniques for autonomous driving and advanced driver assistance systems (ADAS), may analyze sensor data in a birds-eye-view (BEV) representation. A BEV representation may include data from one or more sensors, including cameras, LiDAR sensors, radar sensors, and others. One reason for the success of BEV-based processing is the low-level fusion of information from multiple sensors. Rather than performing a perception task (e.g., object detection segmentation, etc.) for each sensor, a BEV network may perform these tasks in a fused BEV representation.

One desirable extension of BEV processing are temporal BEV networks. In addition to fusing information from multiple sensors, temporal BEV networks may also fuse information temporally, adding historical information from previous timepoints to improve the predictions at the current time. However, there are two major challenges with temporal BEV networks:

One challenge is training memory limitation. The training of temporal BEV networks may be limited by hardware memory. As the multiple sensor input size is normally quite large, only a relatively smaller number of samples can typically be used in a single training iteration. This hinders the learning of long-range temporal dependencies. Another challenge relates to the asynchronous nature of the input sensors. Different sensors, such as cameras, radars and LiDARs are typically not synchronized. Different sensors may operate on different frame rates or have the same frame rate, but different capture times. This makes temporal fusion difficult.

In view of these drawbacks, this disclosure describes techniques for using time-continuous recurrent neural networks (RNNs) when performing a perception task. Time-continuous RNNs differ from traditional RNNs in that time-continuous RNNs are not limited to observations at fixed-interval timepoints. Rather, time-continuous RNNs may model feature vector dynamics over time. For example, a time-continuous RNN may use an exponential decay function or another function to estimate feature vector values between a start value (e.g., a feature vector value associated with an observation) and a predicted long-term steady state value at a future time (e.g., near an expected second observation).

By explicitly accounting for the time between inputs, time-continuous RNNs can update their internal states smoothly across uneven intervals. This allows a time-continuous RNN to more accurately reflect the temporal dependencies in data that might not be regularly spaced, as is often the case with asynchronous sensor inputs. As such, a time-continuous RNN may more accurately represent feature vector values for systems with multiple asynchronous sensor inputs, such as in computer visions systems for automotive that may use multiple camera sensors, as well as other sensors such as LiDAR, radar, sonar, and others. Furthermore, a time-continuous RNN may allow for better training, as the ability to generate gradients from disparate time instances is readily available, thus allowing a time-continuous RNN to be trained using long-term temporal dependencies in the training dataset. Accordingly, the use of time-continuous RNNs as described herein may result in more accurate outputs of various perception tasks, such as semantic segmentation, semantic occupancy prediction, lane tracking, or 3D object detection.

In one example, this disclosure describes an apparatus configured to perform a perception task, the apparatus comprising a memory, and processing circuitry connected to the memory, the processing circuitry configured to generate sensor features from data from one or more sensors, process the sensor features with a time-continuous RNN to produce time-continuous features, and perform the perception task using the time-continuous features.

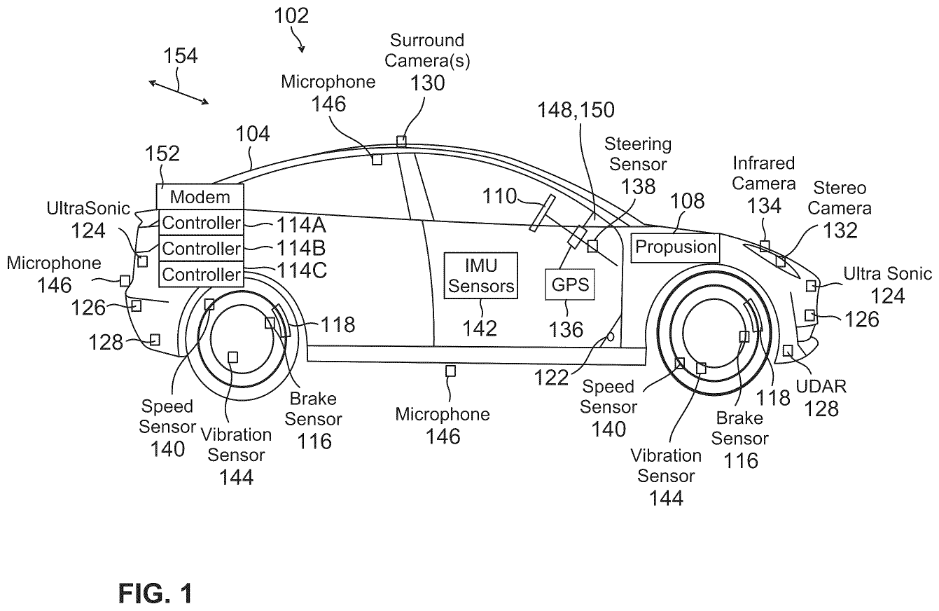

FIG. 1 shows an example vehicle 102 that may be configured to use time-continuous RNNs to perform perception tasks in one or more examples of this disclosure. Vehicle 102 in the example shown may comprise a passenger vehicle such as a car or truck that can accommodate a human driver and/or human passengers. In one example, vehicle 102 may comprise an autonomous vehicle, semi-autonomous vehicle and may include an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs from the following sensors, including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

As discussed above, computer vision techniques, including techniques for autonomous driving and ADAS, may analyze sensor data in a BEV representation. A BEV representation in computer vision refers to a top-down perspective of a scene, as if viewed from above, similar to the perspective of a bird flying overhead. A BEV representation is particularly valuable in applications such as autonomous driving, robotics, and surveillance, where understanding the spatial layout and relationships between objects on the ground plane is beneficial.

In the context of computer vision, one example of generating a BEV representation involves transforming image data from one or more cameras into a top-down view. This process often uses algorithms to account for perspective distortions and accurately projects objects'positions on the ground plane. BEV representations can provide a comprehensive overview of the environment, including the relative positions of vehicles, pedestrians, road markings, and other relevant features.

This top-down perspective simplifies various tasks in computer vision, such as object detection, tracking, and path planning, by reducing the complexity of the scene and offering a more intuitive understanding of spatial relationships. Additionally, BEV representations are often integrated with data from other sensors, such as LiDAR or radar, to enhance accuracy and robustness in dynamic and complex environments. One reason for the success of BEV-based processing is the low-level fusion of information from multiple sensors. Rather than performing a perception task (e.g., object detection segmentation, etc.) for each sensor, a BEV network may perform these tasks in a fused BEV representation.

As discussed above, one desirable extension of BEV processing are temporal BEV networks. In addition to fusing information from multiple sensors, temporal BEV networks may also fuse information temporally, adding historical information from previous timepoints to improve the predictions at the current time. However, there are two major challenges with temporal BEV networks:

One challenge is training memory limitation. The training of temporal BEV networks may be limited by hardware memory. As the multiple sensor input size is normally quite large, only a relatively smaller number of samples can typically be used in a single training iteration. This hinders the learning of long-range temporal dependencies. Another challenge relates to the asynchronous nature of the input sensors. Different sensors, such as cameras, radars and LiDARs are typically not synchronized. Different sensors may operate on different frame rates or have the same frame rate, but different capture times. This makes temporal fusion difficult.

In view of these drawbacks, this disclosure describes techniques for using a time-continuous RNN when performing a perception task. An RNN is a type of neural network architecture designed to handle sequential data by maintaining an internal memory (or “hidden state”) that captures dependencies between elements in a sequence. In computer vision, RNNs may be applied to tasks where understanding temporal or sequential patterns in data is useful, such as video analysis, motion tracking, or action recognition. RNNs can process sequential frames of video, allowing the model to learn patterns over time rather than treating each frame as an independent entity. This capability may be especially useful for capturing dynamic changes, temporal relationships, or continuity in visual data.

One feature of RNNs is that the output at each time step is influenced not only by the current input but also by the outputs of previous time steps. This allows RNNs to more effectively model time dependencies in sequences, such as changes in pixel values across video frames. However, traditional RNNs have limitations, such as struggling with long-term dependencies due to issues like vanishing gradients, which is why advanced variants like Long Short-Term Memory (LSTM) and Gated Recurrent Units (GRUs) may be used for complex temporal tasks.

A time-continuous RNN is an extension of the RNN designed to handle continuous, time-varying input signals more naturally, rather than discrete sequences of inputs. In computer vision, time-continuous RNNs can be useful in tasks involving the continuous flow of visual information, such as real-time video analysis or optical flow estimation. A time-continuous RNN may be configured to model continuous changes in the input data over time, often using differential equations or other functions (e.g., exponential decay) to model changes in the hidden state. This allows time-continuous RNNs to capture fine-grained, continuous temporal dynamics more effectively than traditional, discrete RNNs, making continuous RNNs useful for tasks that benefit from high temporal resolution or for environments where input data changes fluidly over time.

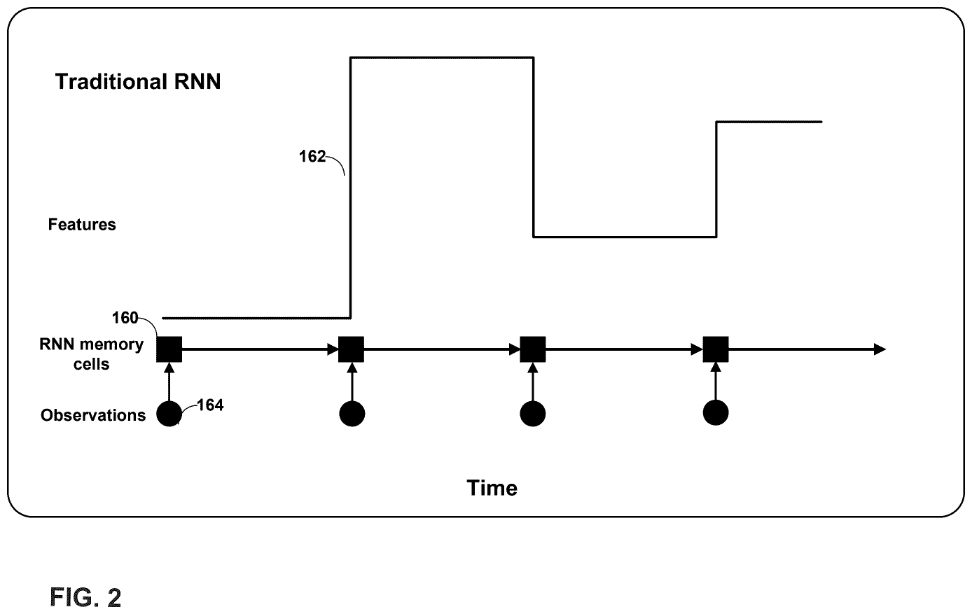

Accordingly, time-continuous RNNs differ from traditional RNNs in that time-continuous RNNs are not limited to observations at fixed-interval timepoints. Rather, time-continuous RNNs may model feature vector dynamics over time. FIG. 2 is a conceptual diagram illustrating an example feature vector over time of a traditional RNN. As shown in FIG. 2, RNN memory cells 160 store the value of features 162. Features 162 may be feature vectors generated by a feature extractor (e.g., a convolutional neural network) from one or more input sensors. In some examples, the feature vectors may be in the form of a BEV representation. As shown in FIG. 2, for a traditional RNN, the value of features 162 is determined at a particular observation time 164 (e.g., when data from an input sensor is captured) and remains constant until the next observation time. In the context of this disclosure, an observation time or observation is a time at which data from one or more input sensors is captured.

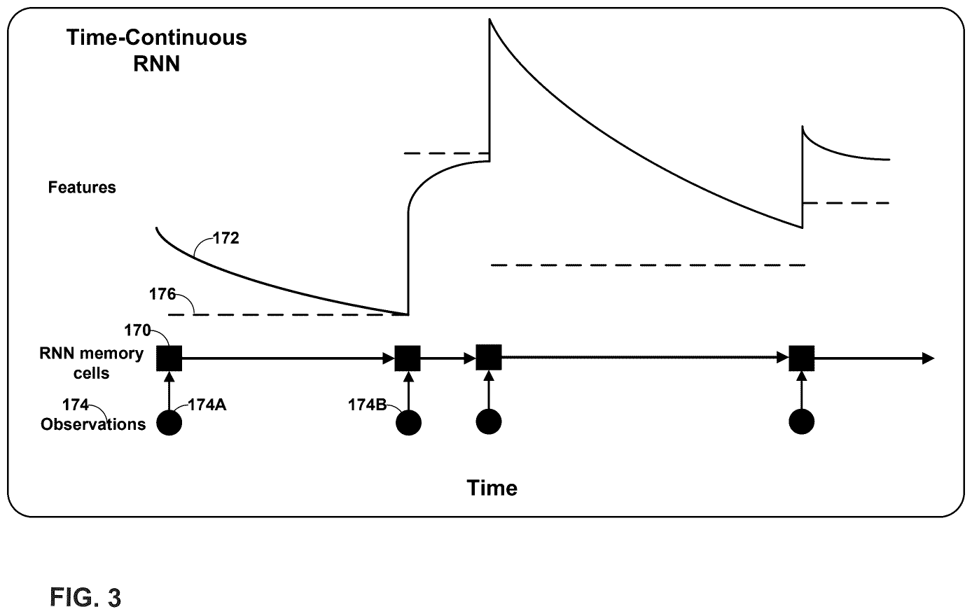

FIG. 3 is a conceptual diagram illustrating an example feature vector over time of a time-continuous RNN. As shown in FIG. 3, RNN memory cells 170 store the value of features 172. Features 172 may be feature vectors generated by a feature extractor (e.g., a convolutional neural network) from one or more input sensors. Again, the feature vectors may be in the form of a BEV representation. As shown in FIG. 3, for a time-continuous RNN, the value of features 172 may be determined at a particular observation time 174. However, rather than just storing a constant value, the time continuous RNN may also predict a steady state value of features 172 at a future observation time, as well as determine a function that estimates feature values between an initial feature value and the predicted steady state value.

For example, in FIG. 3, a time-continuous RNN may determine a first feature vector value from data from one or more inputs sensors at observation time 174A. The time-continuous RNN may also predict a second feature vector value 176 (e.g., the steady state value). As shown in FIG. 3, the second feature vector value 176 is the predicted steady state value of features 172 as time increases. The time-continuous RNN may then also determine a function that estimates feature vector values between the first feature vector value and the steady state value. As shown in FIG. 3, the values of features 172 may fall along a curve defined by a function between the first feature vector value at observation 174A and the second feature vector value 176. That is, the estimated feature vector values are defined by a function. The function may be an exponential decay function, defined by an ordinary differential equation, or defined by another type of function.

The time continuous RNN may store the parameters of the function as the state at a particular observation time. The parameters of the function may include the first feature vector value and the predicted second feature vector value (e.g., the steady state value). Using this function, a decoder configured to perform a perception task may determine feature vector values at any arbitrary time in the data set, and is not limited to only the feature vector values at observations times.

By explicitly accounting for the time between inputs, time-continuous RNNs can update their internal states smoothly across uneven intervals. This allows a time-continuous RNN to more accurately reflect the temporal dependencies in data that might not be regularly spaced, as is often the case with asynchronous sensor inputs. As such, a time-continuous RNN may more accurately represent feature vector values for systems with multiple asynchronous sensor inputs, such as in computer visions systems for automotive that may use multiple camera sensors, as well as other sensors such as LiDAR, radar, sonar, and others. Furthermore, a time-continuous RNN may allow for better training, as the ability to generate gradients from disparate time instances is readily available, thus allowing a time-continuous RNN to be trained using long-term temporal dependencies in the training dataset. Accordingly, the use of time-continuous RNNs as described herein may result in more accurate outputs of various perception tasks, such as semantic segmentation, semantic occupancy prediction, lane tracking, or 3D object detection.

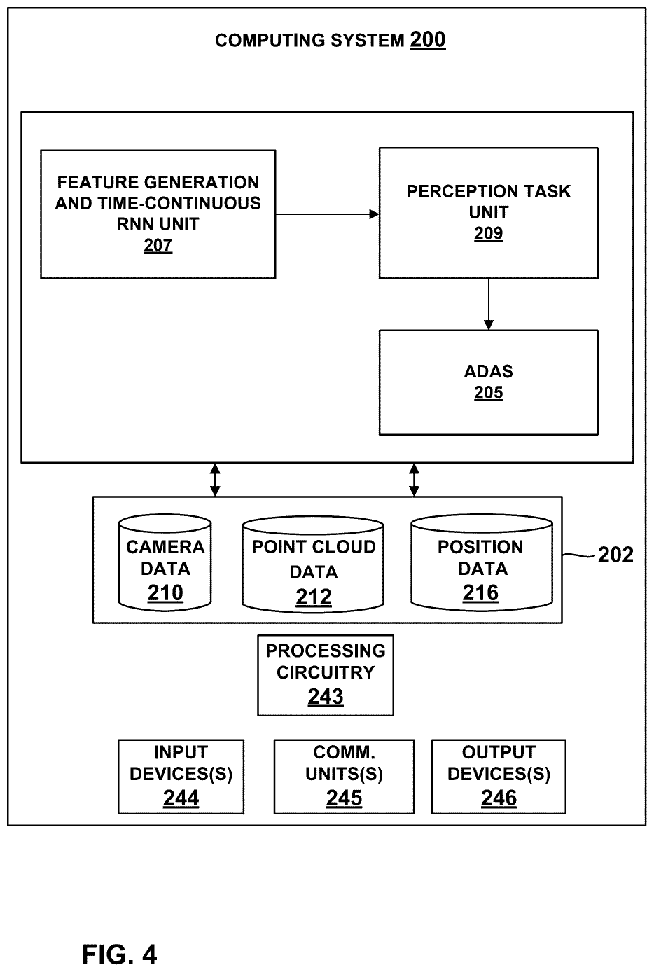

In one example, controller 114 may be configured to generate sensor features from data from one or more sensors, process the sensor features with a time-continuous RNN to produce time-continuous features, and perform the perception task using the time-continuous features. Additional details on the time-continuous RNN techniques of this disclosure are described below with reference to FIGS. 4-9.

FIG. 4 is a block diagram illustrating an example computing system 200. As shown, computing system 200 comprises processing circuitry 243 and memory 202. The processing circuitry 243 is configured for executing feature generation and time-continuous RNN unit 207, perception task unit 209, and ADAS 205, which may represent an example instance of any controller 114 described in this disclosure, such as controller 114 of FIG. 1. The example of FIG. 4 shows feature generation and time-continuous RNN unit 207, perception task unit 209, and ADAS 205 as being separate units. In other examples, feature generation and time-continuous RNN unit 207 and perception task unit 209 may be a sub-units of ADAS 205.

Computing system 200 may also be implemented as any suitable external computing system accessible by controller 114, such as one or more server computers, workstations, laptops, mainframes, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for using a time-continuous RNN to perform perception tasks may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network - PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/deactivate cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., feature generation and time-continuous RNN unit 207, perception task unit 209, and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 4.

Processing circuitry 243 may execute feature generation and time-continuous RNN unit 207, perception task unit 209, and/or ADAS 205 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, ranging sensor (e.g., one or more of radar, sonar, LiDAR, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 4, computing system 200 may be configured to execute feature generation and time-continuous RNN unit 207, perception task unit 209, and ADAS 205. Perception task unit 209 may be configured to perform one or more perception tasks using time-continuous features generated by feature generation and time-continuous RNN unit 207. Feature generation and time-continuous RNN unit 207 may be configured to generate time-continuous features from data from one or more sensors. In one example, the one or more sensors may include one more of camera sensor(s) (e.g., one or more of cameras 130 of FIG. 1) that produces camera data 210, a LiDAR sensor (e.g., LiDAR sensor 128 of FIG. 1) that produces point cloud data 212, or one or more other sensors (e.g., sonar, radar, etc.).

At a high level, feature generation and time-continuous RNN unit 207 may be configured to generate sensor features from data from one or more sensors. As one example, the data may include camera data 210 and/or point cloud data 212. In one example, the sensor features are BEV sensor features. In this example, to generate the sensor features from the data from the one or more sensors, feature generation and time-continuous RNN unit 207 may be configured to generate respective sensor features from the one or more sensors, and generate, using the respective sensor features, a BEV representation having the BEV sensor features.

Feature generation and time-continuous RNN unit 207 may then process the sensor features with a time-continuous RNN to produce time-continuous features. Perception task unit 209 may then perform a perception task using the time-continuous features. Because feature generation and time-continuous RNN unit 207 produces time-continuous features, as shown in FIG. 3, perception task unit 209 may perform the perception task using estimated feature vector values from the time-continuous features from any time between two observation times, including at the observation times themselves.

The time-continuous features are defined by a first feature vector value corresponding to a first observation time of the one or more sensors, a prediction of a steady state feature vector value, and estimated feature vector values between the first feature vector value and the steady state feature vector value. The estimated feature vector values are defined by a function. The function is an exponential decay function or is defined by an ordinary differential equation.

There are many alternative variations of time-continuous RNNs that may be used in feature generation and time-continuous RNN unit 207. For example, a time-continuous RNN may use a general ordinary differential equation to model the dynamics of feature vectors between observations. In the context of computer vision, an ordinary differential equation (ODE) may be often used to model the continuous evolution of certain variables over time, such as feature vectors between a first feature vector value (e.g., a feature vector associated with an observation), and a second feature vector value (e.g., a steady state value predicted by a time-continuous RNN). ODEs describe how a quantity changes in relation to another, typically time. Other time-continuous RNNs may be dependent on the most recently observed sensor.

In one example, the time-continuous RNN of feature generation and time-continuous RNN unit 207 may use a time-continuous Long Short-Term Memory (LSTM) network. This allows the model to update its internal state as time passes and as new events occur, while also accounting for the decay of influence that previous events have on the likelihood of future events.

In another example, the time-continuous RNN of feature generation and time-continuous RNN unit 207 may use an ODE technique that includes exponential decay and optional periodic dynamics to model feature vector dynamics over time. The time-continuous latent state allows the model to make predictions at any time point. The time-continuous RNN may combine a graph structure with temporal updates via gated recurrent units (GRUs) to manage latent state dynamics. When new observations are obtained, the latent state of each node of the network may be updated using a GRU, while between observations, the state evolves according to the ODE, allowing the model to capture both short-and long-term dependencies.

As will be explained in more detail below, feature generation and time-continuous RNN unit 207 may be configured to generate time-continuous features in the context of a temporal BEV network. As one example, feature generation and time-continuous RNN unit 207 may be configured to receive current BEV sensor features at a current time, as well as receive previous BEV sensor features from a previous time. Feature generation and time-continuous RNN unit 207 may perform ego motion compensation on the previous BEV sensor features to warp the previous BEV sensor features to a pose of the current BEV sensor features to create warped BEV sensor features. This warping process may use position data 216. Position data 216 may include data that indicates the position, velocity, and/or acceleration of the vehicle over time, such that the pose of the vehicle may be determined at both the previous time and the current time. Feature generation and time-continuous RNN unit 207 may then combine the warped BEV sensor features and the current BEV sensor features to form combined BEV sensor features, and then process the combined BEV sensor features with the time-continuous RNN to form the time-continuous features.

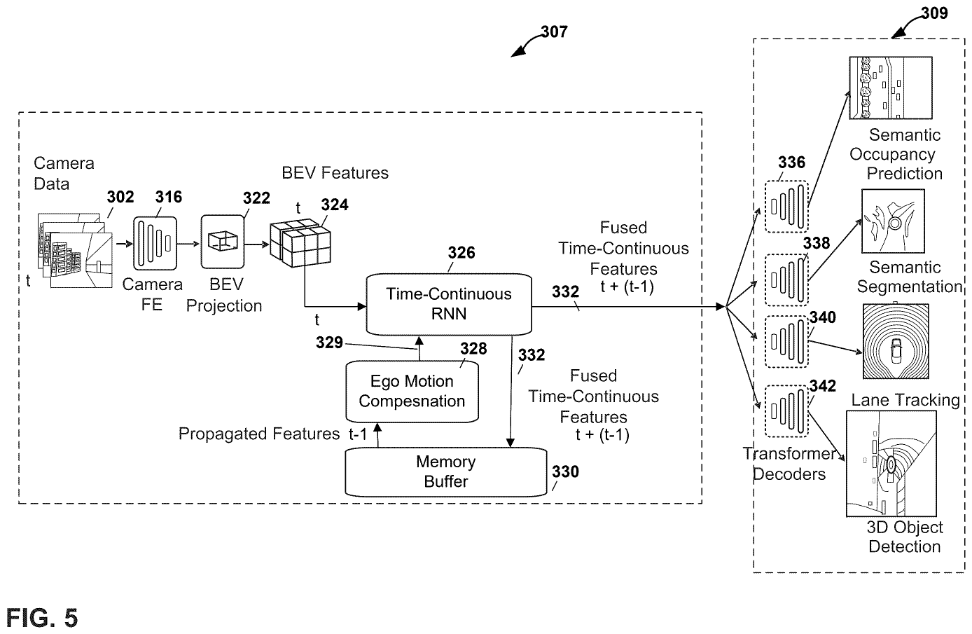

As mentioned above, feature generation and time-continuous RNN unit 207 may provide the time-continuous features to perception task unit 209. Perception task unit 209 may be configured to perform a perception task using the time-continuous features. For example, perception task unit 209 may perform the perception task with a task-specific transformer decoder using the time-continuous features as input. The perception task may include one or more of semantic segmentation, semantic occupancy prediction, lane tracking, or 3D object detection. ADAS 205 may be configured to control a vehicle at least in part based on an output of the perception task. A more detailed description of the operation of feature generation and time-continuous RNN unit 207 and perception task unit 209 is described below with reference to FIGS. 5-8.

FIG. 5 is a block diagram illustrating an example of temporal BEV processing using a time-continuous RNN in accordance with the techniques of this disclosure. FIG. 5 shows feature generation and time-continuous RNN unit 307 that is one example of feature generation and time-continuous RNN unit 207 of FIG. 4. FIG. 5 also shows perception task unit 309 that is one example perception task unit 209 of FIG. 4.

Feature generation and time-continuous RNN unit 307 may be configured to generate sensor feature from one or more sensors. As shown in FIG. 5, feature generation and time-continuous RNN unit 307 receives camera data 302 from one or more camera sensors (e.g., cameras 130 of FIG. 1) at time t. Camera data 302 may be individual frames of video data or still images captured at different times.

Feature generation and time-continuous RNN unit 307 may be configured to generate, using camera feature extractor (FE) 316), camera features from camera data 302. Camera feature extractor 316 may be a sensor-specific feature extractor that is configured to operate on specific data types to produce feature vectors. Feature vectors are high-dimensional representations that encapsulate the characteristics of the input data, such as an image or point cloud, in a compact form. One of several techniques may be used to generate feature vectors. Example techniques for feature extraction are described below.

One example for generating feature vectors uses a Scale-Invariant Feature Transform (SIFT), which detects key points in image data or point cloud data and describes them using local gradients. SIFT features are robust to changes in scale, rotation, and illumination, making them suitable for matching and recognition tasks. Another approach for feature vector generation is a Histogram of Oriented Gradients (HOG), which captures the distribution of gradient orientations in localized regions of an image data or point cloud data. HOG features are particularly effective for detecting objects and shapes, as they highlight edge information and structural patterns.

Another technique for feature vector generation uses convolutional neural networks (CNNs). CNNs include multiple layers of convolutional filters that learn to detect various patterns, such as edges, textures, and complex shapes, through hierarchical feature learning. CNNs are trained on large datasets and can generalize well to new image data or point cloud data. The output from the next to last layer of a CNN, often called the feature map, is typically flattened into a feature vector.

In other examples, vision transformers (ViTs) may be used for feature extraction. ViTs divide image data or point cloud data into smaller patches, treat each patch as a token, and process these tokens using self-attention mechanisms. This approach allows the model to capture long-range dependencies and contextual relationships across the entire image or point cloud.

In other examples, features may be extracted using a transformer encoder. Feature extraction using a transformer encoder involves leveraging a self-attention mechanism to capture complex dependencies and contextual information from input data, such as image data or point cloud data. Transformer encoders, originally designed for natural language processing tasks, have been adapted for various applications in computer vision due to their ability to model long-range relationships and global context effectively.

The process begins with dividing the input data into smaller, manageable units. In the case of image data or point cloud data, this involves splitting the input data into patches. Each patch is then flattened and embedded into a high-dimensional space using a learnable linear projection. Positional embeddings may be added to these patch embeddings to retain spatial information.

Once the patches are prepared, they are fed into the transformer encoder, which may include multiple layers of self-attention and feed-forward networks. Each encoder layer may have two main components: a multi-head self-attention mechanism and a position-wise feed-forward network. The self-attention mechanism computes attention scores for each patch relative to all other patches, allowing the model to focus on relevant parts of the input data contextually. These attention scores are used to weight the patches, capturing dependencies and interactions between different parts of the input data.

The multi-head self-attention mechanism enhances this process by allowing the model to attend to multiple aspects of the data simultaneously. The multi-head self-attention mechanism does so by projecting the input into several subspaces (e.g., heads), performing self-attention in each subspace independently, and then concatenating the results. This enables the model to capture diverse features and relationships from different perspectives.

Following the self-attention mechanism, the output may be processed by a position-wise feed-forward network, which may include two linear transformations with a rectified linear unit (ReLU) activation in between. The ReLU applies non-linear transformations to each patch independently, further refining the extracted features. The output from the feed-forward network is then passed to the next encoder layer, and this process is repeated for a predetermined number of layers. At the end of the transformer encoder, the output feature vectors from the final layer represent a set of features extracted from the input data.

BEV projection unit 322 may then project the camera sensor features into a BEV representation that includes BEV features 324. Projecting camera sensor features into a BEV representation is useful for applications such as autonomous driving, where understanding the spatial layout from a top-down perspective enhances scene comprehension and decision-making. BEV projection unit 322 may use one of several techniques to achieve a BEV projection, including lift, splat, and shoot methods.

In accordance with the techniques of this disclosure, BEV features at time t are supplied to time-continuous RNN 326. Time-continuous RNN also access propagated features from time t−1 (e.g., generally some time before time t) from memory buffer 330. In one example, propagated features from t−1 are previous BEV sensor features captured at a time previous to that of time t. In this example, the propagated features may be fused BEV features from two previous times (e.g., time t−1 and time t−2). The propagated BEV features may then be fused with the BEV sensor features at current time t.

Before the fusion of the current BEV sensor features and the propagated (e.g., previous) BEV sensor features, ego motion compensation unit 328 may perform a warping process on the propagated BEV sensor features to match the post of the current BEV sensor features to created warped BEV sensor features 329.

Ego-motion compensation in computer vision, particularly in the context of BEV applications, refers to the process of adjusting for the movement of the camera or vehicle to maintain a consistent and accurate representation of the surrounding environment. In BEV applications, such as autonomous driving, surveillance, or aerial mapping, the camera or sensor capturing the scene is often in motion, either mounted on a moving vehicle or drone. Ego-motion introduces shifts in the perspective, which can distort the representation of the scene if not compensated for.

Ego motion compensation unit 328 is configured to adjust for the movements of the camera or platform (such as rotation, translation, and changes in altitude), so that such movements do not adversely affect the interpretation of the surrounding environment from a top-down perspective. By tracking the motion of the vehicle or sensor (e.g., using position data 216 shown in FIG. 4), ego motion compensation unit 328 corrects or compensates for these movements, allowing the system to maintain a stable and consistent BEV image. Ego motion compensation unit 328 estimates the camera's motion, often using inputs like inertial measurement units (IMUs), GPS, and visual odometry, and then adjusts the propagated BEV features output to remove the motion artifacts.

Time-continuous RNN 326 then combines the warped BEV sensor features 329 and the current BEV sensor features 324 to form fused time-continuous features 332. The fused time-continuous features 332 represent features from both the current time t as well as the propagated features from previous time t−1. Time-continuous RNN 326 may store the fused time-continuous features 332 in memory buffer 300 for use at a future time. In addition, time-continuous RNN 326 may provide time-continuous features 332 to perception task unit 309 to perform a perception task.

In one example of the disclosure, time-continuous RNN 326 may be implemented with a time-continuous gated recurrent unit (GRU), that is configured to fuse BEV features 324 with the warped BEV sensor features 329. A time-continuous GRU manages this sequential information by updating a hidden state in a recurrent manner, selectively retaining or forgetting parts of the historical information based on its relevance to the current data. As described above, before fusing the features, the BEV features from a previous time or observation are warped based on an ego vehicle's pose transformation. This warping ensures that the temporal information is spatially aligned across frames, accounting for the movement of the vehicle. After warping, the features are fed into the time-continuous GRU, which updates the hidden state with new information while preserving relevant details from past frames.

In other examples, time-continuous RNN 326 may be implemented using one or more convolutional GRUs. In some examples, time-continuous RNN 326 may use one or more GRUs that process every pixel of a BEV feature tensor individually. In other examples, time-continuous RNN 326 may use one or more convolutional GRUs that also consider neighboring pixels.

In particular, the new “state” are fused time-continuous features that are defined by a first feature vector value (e.g., the value of the fused time-continuous features at time t), corresponding to a first observation time (t) of the one or more sensors, a prediction of a second feature vector value (e.g., the predicted steady state value described above), and estimated feature vector values between the first feature vector value and the steady state feature vector value. In this context, the estimated feature vector values are not themselves stored, but may be defined by a function. Another processing unit, such as perception task unit 309, may determine the estimated feature vector values at any arbitrary time after the first observation using the parameters of the function. As described above, the function may be an exponential decay function, defined by an ordinary differential equation, or be defined by another function.

In more detail, in one example, a time-continuous RNN may update its state based on a generated feature vector at time t, a predicted steady-state feature vector, and a function modeling the change between these vectors. The update mechanism may be described in terms of continuous dynamics and differential equations.

The generated feature vector at time t is a feature vector representing the network's state at the current time t (e.g., the fused time-continuous features 332 at time t). The predicted steady-state feature vector is the prediction by the time-continuous RNN of the steady-state feature vector. The function modeling the change in the feature vectors models how the feature vector evolves from the current state at time t to the predicted steady-state value. This function may define the change or gradient between these two vectors.

Given these components, the continuous-time dynamics can be described using a differential equation that governs how the state evolves over time. This function models the idea that the state of feature vector values gradually evolves over time toward the steady-state vector, with the speed and direction of the evolution being proportional to the difference between the current state and the steady-state value. The differential equation implies that feature vector values will asymptotically approach the steady-state value over time.

Perception task unit 309 may use the fused time-continuous features 332 in various autonomous perception tasks with task-specific transformer decoder heads. FIG. 5 shows an example of a first decoder 336 for semantic occupancy prediction, a second decoder 338 for semantic segmentation, a third decoder 340 for lane tracking, and a fourth decoder 342 for 3D objection detection. Of course, more or fewer transfer decoders may be used.

As discussed above, because the fused-time continuous features 332 are defined by a function that estimates values of the feature vectors between a current time t and some predicted feature vector value at a future time, perception task unit 309 may determine feature vector values from the fused time-continuous features 332 at any arbitrary time, and is not limited to performing perception tasks at specific observation times. More generally, perception task unit may perform a perception task using estimated feature vector values from a time between a first observation time and a second observation time. In this regard, perception task unit 309 need not receive fused time-continuous features 332 directly from time-continuous RNN 326, but may also access time-continuous features 332 from memory buffer 330 for performing a perception task at any arbitrary time.

While the above example is described with reference to a temporal network, the time-continuous RNN techniques of this disclosure may also be used with non-temporal networks. For example, for a non-temporal network, memory buffer 300 may be replaced with a short term memory. The short term memory will not store information between frames, but just within the same frame to handle feature vectors received from asynchronous sensors.

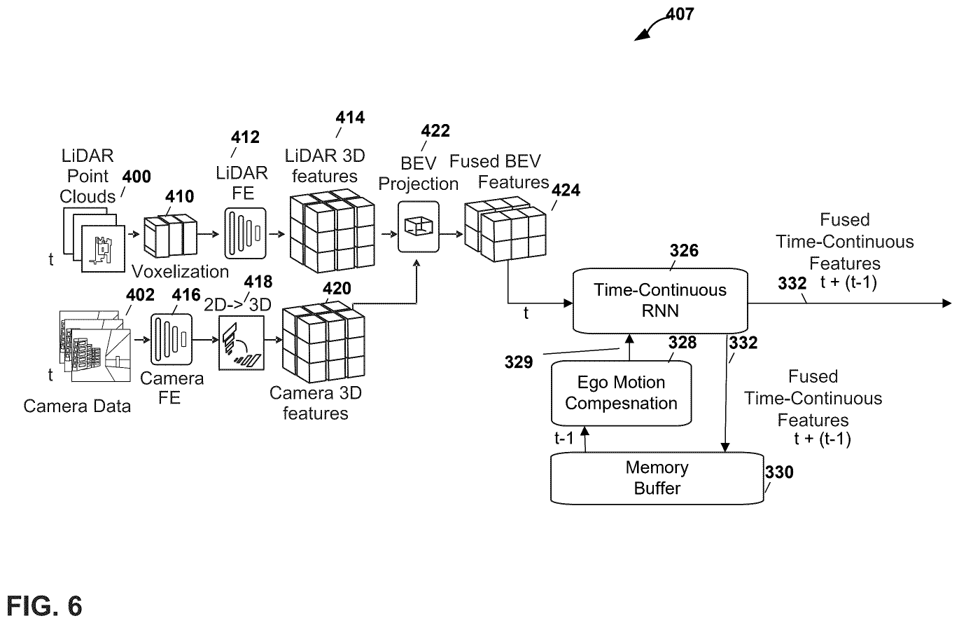

FIG. 6 is a block diagram illustrating another example of temporal BEV processing using a time-continuous RNN in accordance with the techniques of this disclosure. FIG. 6 shows feature generation and time-continuous RNN unit 407 that is one example of BEV and feature generation and time-continuous RNN unit 207 of FIG. 4. Similar to FIG. 5, FIG. 6 shows an example of temporal BEV processing where the input is from multiple different types of sensors. The time-continuous RNN 326, ego motion compensation unit 328, and memory buffer 330 of FIG. 6 are the same as those described above in FIG. 5.

Feature generation and time-continuous RNN unit 407 may be configured to generate sensor feature from one or more sensors. As shown in FIG. 6, feature generation and time-continuous RNN unit 407 receives point cloud data 400 from a LiDAR sensor (e.g., LiDAR sensor 128 of FIG. 1) and camera data 402 from one or more camera sensors (e.g., cameras 130 of FIG. 1). Camera data 402 may be individual frames of video data or still images captured at different times. Similarly, point cloud data 400 may be individual frames of point cloud data captured at different times.

Voxelization unit 410 may be configured to convert point cloud data 400 into a voxelized representation, which is called the voxelized point cloud data. Voxelization of a LiDAR point cloud is a process that converts the raw point cloud data, which includes a large number of individual 3D points, into a structured, grid-like representation called voxels. A voxel, or volumetric pixel, is a cubic unit in a 3D grid that represents a specific portion of space. Voxelization unit 410 may operate according to a size and resolution of the voxel grid, which determines the level of detail in the final representation. This grid divides the entire spatial domain of the point cloud into discrete, uniformly sized cubes. Voxelization unit 410 may analyze each voxel to determine whether the voxel contains any points from the original point cloud data.

During the voxelization process, voxelization unit 410 assigns each point from the LiDAR point cloud to its corresponding voxel based on its spatial coordinates. If a point falls within the boundaries of a voxel, voxelization unit 410 marks that voxel as occupied. Various algorithms can be used to populate the voxel grid, including occupancy grids or more sophisticated methods that account for point density, intensity values, or other attributes. This transformation simplifies the raw data, making it easier to process and analyze. By aggregating points into voxels, the complexity of the point cloud is reduced, and the data becomes more manageable for subsequent processing tasks such as object detection, segmentation, and classification.

The voxelized representation of point cloud data 400 offers several advantages. The voxelized representation provides a structured and regularized form of the data, which is beneficial for various computational algorithms and machine learning models that operate on uniform input formats. Additionally, voxelization facilitates efficient spatial queries and operations, such as collision detection and nearest-neighbor searches, by leveraging the grid structure. Furthermore, the voxel grid can be easily integrated with other sensor data or used in simulations and visualizations to provide a more comprehensive understanding of the environment.

Feature generation and time-continuous RNN unit 407 may be configured to generate, using a first feature extractor (e.g., LiDAR feature extractor (FE) 412), LiDAR 3D features 414 from the voxelized point cloud data, and generate, using a second feature extractor (e.g., camera feature extractor (FE) 416), camera features from camera data 402. Camera feature extractor 416 and LiDAR feature extractor 412 may be sensor-specific feature extractors that are configured to operate on specific data types to produce feature vectors. Feature vectors are high-dimensional representations that encapsulate the characteristics of an image or point cloud in a compact form. One of several techniques may be used to generate feature vectors. Example techniques for feature extraction were described above and may also be used in the example of FIG. 6.

Next, feature generation and time-continuous RNN unit 407 may extract features from the camera features produced by camera feature extractor 416 and from LiDAR 3D features 414. Point cloud data 400 from a LiDAR sensor provides direct 3D information about the environment. To encode the camera features, feature generation and time-continuous RNN unit 407 may apply a 2D to 3D lifting operation 418 to camera features produced by camera feature extractor 416 to generate camera 3D features 420. 2D to 3D lifting operation 418 may use learned projections and depth supervision from point cloud data 400 (e.g., using LiDAR 3D features 414).

As one example, 2D to 3D lifting operation 418 may generate camera 3D features through a process of implicit unprojection (e.g., using a lift, splat, shoot technique), which involves transforming the 2D pixel coordinates into 3D space. 2D to 3D lifting operation 418 may first perform a “lifting” operation, where for each pixel in the image, a distribution over possible depths is predicted. Instead of directly determining the depth of each pixel, 2D to 3D lifting operation 418 generates a frustum-shaped set of points that represent possible locations the pixel could map to in 3D space.

Each pixel is thus lifted from its 2D image plane into a frustum of potential 3D positions, based on intrinsic and extrinsic camera parameters. 2D to 3D lifting operation 418 may populate these frustums with context features, capturing both semantic and spatial information about the scene. 2D to 3D lifting operation 418 may then “splat” these features onto a predefined 3D grid (e.g., in a BEV representation), which allows the combination of information from multiple cameras into a unified 3D representation of the scene.

Once depth information is obtained from 2D to 3D lifting operation 418, the depth information can be combined with the 2D image coordinates to generate camera 3D features 420.

BEV projection unit 422 may then fuse and project LiDAR 3D features 414 and camera 3D features 420 into a BEV representation that includes fused BEV features 424. That is, fused BEV features 424 include both LiDAR 3D features 414 and camera 3D features 420. As described above, projecting camera and LiDAR features into a BEV representation is useful for applications such as autonomous driving, where understanding the spatial layout from a top-down perspective enhances scene comprehension and decision-making. BEV projection unit 422 may use one of several techniques to achieve a BEV projection, including lift, splat, and shoot methods. An example of a lift, splat, shoot is described below.

A “lift” technique involves transforming 2D camera features into 3D space before projecting them onto the BEV plane. This process is achieved by 2D to 3D lifting operation 418, as described above.

The “splat” technique focuses on projecting LiDAR points from LiDAR 3D features 414 directly into the BEV space and then splatting or spreading the associated features across the BEV grid. In this approach, each LiDAR point, along with its attributes (such as intensity or reflectivity), is projected onto the BEV plane. The features from the points are then distributed or “splatted” over the BEV grid cells they fall into, e.g., using a Gaussian kernel or other spreading functions to ensure smooth and continuous feature representation.

Time-continuous RNN 326 may then process fused BEV features 424 in the same manner as described above with reference to FIG. 5 to generate fused time-continuous features 332. Time-continuous features 332 may then be provided to perception task unit 309 (see FIG. 5) to perform one or more perception tasks.

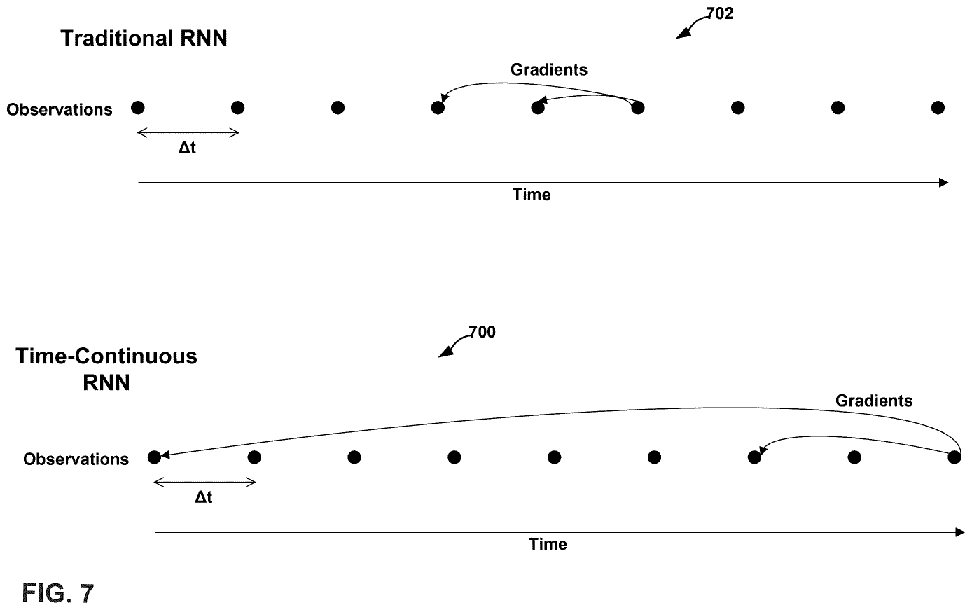

FIG. 7 is a conceptual diagram illustrating example training processes in accordance with the techniques of this disclosure. Using the time-continuous RNNs described above in BEV networks facilitates better training of the network. When training any of the time-continuous RNNs of this disclosure, the training process may sample observations with long time-distance in the same training batch memory by not sampling every consecutive observation, and thus propagating gradients between distant timepoints to learn more long-range dependencies, as shown in process 700.

Stateful RNN training (i.e., not sampling observations from multiple timepoints in the same sequence in the same batch, but instead in sequential batches storing the previous batch values for the hidden states) will also be simpler as switching sequences in the sampling can be done more often when not sampling every consecutive observation (e.g., as in traditional RNN training in process 702) and still train on longer time ranges. Training on the same sequence for too long could otherwise make the optimization difficult due to limited variability.

As one example, in some implementations, a maximum batch size of 3 may fit into GPU memory in a stateless example. With traditional RNNs (e.g., process 702), subsequent sampling is used and temporal dependencies of a maximum 2Δt time distance can be learned. With time-continuous RNNs (process 700), training algorithms are free to sample any timepoints, and temporal dependencies of any time distance can be learned.

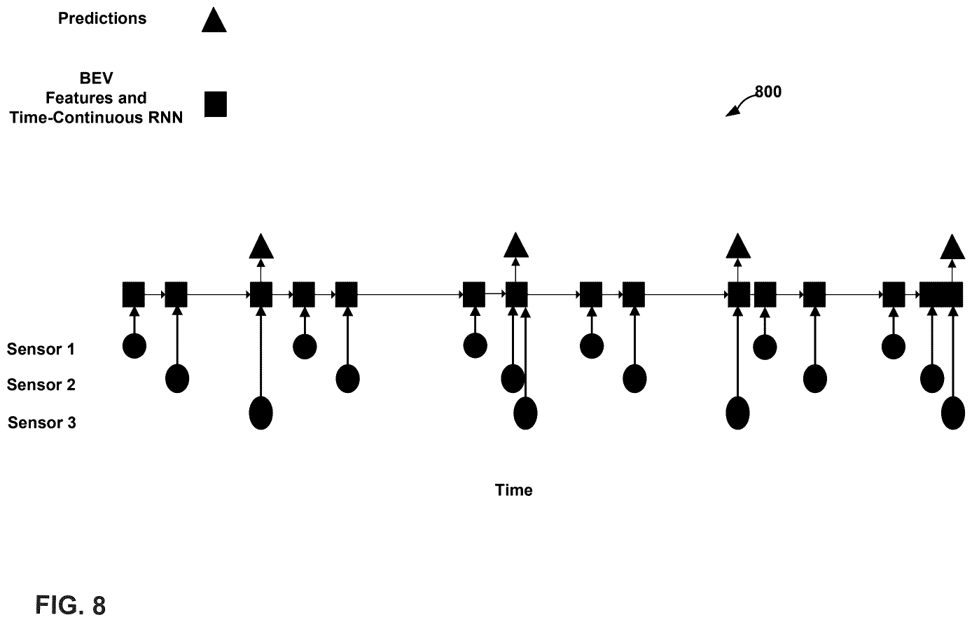

FIG. 8 is a conceptual diagram illustrating example timings of perception tasks in accordance with the techniques of this disclosure. In particular, FIG. 8 shows a scenario 800 where time-continuous features produced by the techniques of this disclosure are particularly useful when multiple sensors may produce outputs at asynchronous time points. As shown in FIG. 8, scenario 800 shows three sensors (sensors 1-3) that perform observations, and generate BEV features, at irregular time points. If those BEV features are processed using the time-continuous RNN techniques of this disclosure, and produce time-continuous features, the time-continuous features may be used for prediction (e.g., by perception task unit 209) at any arbitrary time, regardless of what sensors have contributed to the latest BEV features. In the example of FIG. 8, the same model could be used for updating the time-continuous features regardless of sensor or a separate model may be used to update the time-continuous features for each sensor.

Accordingly, the techniques of this disclosure may provide for the following benefits. Time-continuous RNNs also allows for making predictions at arbitrary time points. Arbitrary timepoints can also be used during training if some ground truth is only valid at some time points, e.g., for dynamic objects. Predictions at arbitrary timepoints can be useful during run-time, enabling use of the same networks in multiple different compute stacks with, e.g., different desired prediction frame rates. As discussed above, asynchronous sensors are problematic for both temporal and non-temporal BEV networks. Thus, the techniques of this disclosure may be used with any networks that use inputs from asynchronous sensors.

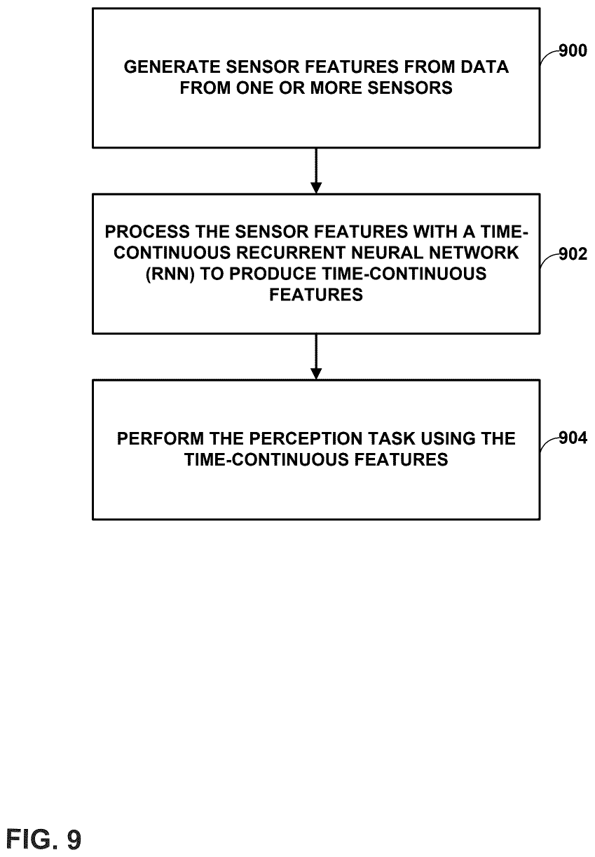

FIG. 9 is a flowchart illustrating an example process in accordance with the techniques of this disclosure. The techniques of FIG. 9 may be performed by one or more controller 114 of FIG. 1 and/or computing system 200. For ease of description, FIG. 9 will be described with reference to computing system 200.

In one example of the disclosure, computing system 200 may be configured to generate sensor features from data from one or more sensors (900), process the sensor features with a time-continuous recurrent neural network (RNN) to produce time-continuous features (902), and perform the perception task using the time-continuous features (904).

In one example, the time-continuous features are defined by a first feature vector value corresponding to a first observation time of the one or more sensors, a prediction of a steady state feature vector value, and estimated feature vector values between the first feature vector value and the steady state feature vector value, the estimated feature vector values being defined by a function. The function may be an exponential decay function or may be defined by an ordinary differential equation.

In one example, to perform the perception task using the time-continuous features, computing system 200 is configured to perform the perception task using estimated feature vector values from a time after the first observation time.

In another example, the sensor features are birds-eye-view (BEV) sensor features. To generate the sensor features from the data from the one or more sensors, computing system 200 is configured to generate respective sensor features from the one or more sensors, and generate, using the respective sensor features, a BEV representation having the BEV sensor features.

In a further example, to process the sensor features with the time-continuous RNN to produce time-continuous features, computing system 200 is configured to receive current BEV sensor features at a current time, receive previous BEV sensor features from a previous time, warp the previous BEV sensor features to a pose of the current BEV sensor features to create warped BEV sensor features, combine the warped BEV sensor features and the current BEV sensor features to form combined BEV sensor features, and process the combined BEV sensor features with the time-continuous RNN to form the time-continuous features. In a further example, to perform the perception task using the time-continuous features, computing system 200 is configured to process the time-continuous features and the current BEV features using a transformer decoder.

The following numbered clauses illustrate one or more aspects of the devices and techniques described in this disclosure.

Aspect 1. An apparatus configured to perform a perception task, the apparatus comprising: a memory; and processing circuitry connected to the memory, the processing circuitry configured to: generate sensor features from data from one or more sensors; process the sensor features with a time-continuous recurrent neural network (RNN) to produce time-continuous features; and perform the perception task using the time-continuous features.

Aspect 2. The apparatus of Aspect 1, wherein the time-continuous features are defined by a first feature vector value corresponding to a first observation time of the one or more sensors, a prediction of a steady state feature vector value, and estimated feature vector values between the first feature vector value and the steady state feature vector value, the estimated feature vector values being defined by a function.

Aspect 3. The apparatus of Aspect 2, wherein the function is an exponential decay function or is defined by an ordinary differential equation.

Aspect 4. The apparatus of any of Aspects 2-3, where to perform the perception task using the time-continuous features, the processing circuitry is configured to: perform the perception task using estimated feature vector values from a time after the first observation time.

Aspect 5. The apparatus of any of Aspects 1-4, wherein the sensor features are birds-eye-view (BEV) sensor features, and wherein to generate the sensor features from the data from the one or more sensors, the processing circuitry is configured to: generate respective sensor features from the one or more sensors; and generate, using the respective sensor features, a BEV representation having the BEV sensor features.

Aspect 6. The apparatus of Aspect 5, wherein to process the sensor features with the time-continuous RNN to produce time-continuous features, the processing circuitry is configured to: receive current BEV sensor features at a current time; receive previous BEV sensor features from a previous time; warp the previous BEV sensor features to a pose of the current BEV sensor features to create warped BEV sensor features; combine the warped BEV sensor features and the current BEV sensor features to form combined BEV sensor features; and process the combined BEV sensor features with the time-continuous RNN to form the time-continuous features.

Aspect 7. The apparatus of Aspect 6, wherein to perform the perception task using the time-continuous features, the processing circuitry is configured to: process the time-continuous features and the current BEV features using a transformer decoder.

Aspect 8. The apparatus of any of Aspects 1-7, wherein the perception task includes one or more of semantic segmentation, semantic occupancy prediction, lane tracking, or 3D object detection.

Aspect 9. The apparatus of any of Aspects 1-8, wherein the processing circuitry is further configured to: train the time-continuous RNN using training feature vectors from non-consecutive observation times.

Aspect 10. The apparatus of any of Aspects 1-9, wherein the one or more sensors include one or more camera sensors, one or more sonar sensors, one or more radar sensors, or one or more LiDAR sensors, and wherein to generate the sensor features from the data from the one or more sensors, the processing circuitry is configured to: receive the data from the one or more sensors at asynchronous observation times; and generate the sensor features from the data from the one or more sensors at each of the asynchronous observation times.

Aspect 11. The apparatus of any of Aspects 1-10, wherein the processing circuitry is part of an advanced driver assistance system (ADAS), and wherein the ADAS is configured to control a vehicle at least in part based on an output of the perception task.

Aspect 12. A method for performing a perception task, the method comprising: generating sensor features from data from one or more sensors; processing the sensor features with a time-continuous recurrent neural network (RNN) to produce time-continuous features; and performing the perception task using the time-continuous features.

Aspect 13. The method of Aspect 12, wherein the time-continuous features are defined by a first feature vector value corresponding to a first observation time of the one or more sensors, a prediction of a steady state feature vector value, and estimated feature vector values between the first feature vector value and the steady state feature vector value, the estimated feature vector values being defined by a function.

Aspect 14. The method of Aspect 13, wherein the function is an exponential decay function or is defined by an ordinary differential equation.

Aspect 15. The method of any of Aspects 13-14, where to performing the perception task using the time-continuous features comprises: performing the perception task using estimated feature vector values from a time after the first observation time.

Aspect 16. The method of any of Aspects 12-15, wherein the sensor features are birds-eye-view (BEV) sensor features, and wherein generating the sensor features from the data from the one or more sensors comprises: generating respective sensor features from the one or more sensors; and generate, using the respective sensor features, a BEV representation having the BEV sensor features.

Aspect 17. The method of Aspect 16, wherein processing the sensor features with the time-continuous RNN to produce time-continuous features comprises: receiving current BEV sensor features at a current time; receiving previous BEV sensor features from a previous time; warping the previous BEV sensor features to a pose of the current BEV sensor features to create warped BEV sensor features; combining the warped BEV sensor features and the current BEV sensor features to form combined BEV sensor features; and processing the combined BEV sensor features with the time-continuous RNN to form the time-continuous features.

Aspect 18. The method of Aspect 17, wherein performing the perception task using the time-continuous features comprises: processing the time-continuous features and the current BEV features using a transformer decoder.

Aspect 19. The method of any of Aspects 12-18, further comprising: training the time-continuous RNN using training feature vectors from non-consecutive observation times.

Aspect 20. The method of any of Aspects 12-19, wherein the one or more sensors include one or more camera sensors, one or more sonar sensors, one or more radar sensors, or one or more LiDAR sensors, and wherein generating the sensor features from the data from the one or more sensors comprises: receiving the data from the one or more sensors at asynchronous observation times; and generating the sensor features from the data from the one or more sensors at each of the asynchronous observation times.

Aspect 21. A non-transitory computer-readable storage medium storing instructions that, when executed, cause one or more processors to perform any combination of techniques of Aspects 12-20.

Aspect 22. A device comprising means for performing any combination of techniques of Aspects 12-20.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to perform a perception task, the apparatus comprising:
a memory; and
processing circuitry connected to the memory, the processing circuitry configured to:
generate sensor features from data from one or more sensors;
process the sensor features with a time-continuous recurrent neural network (RNN) to produce time-continuous features; and
perform the perception task using the time-continuous features.

2. The apparatus of claim 1, wherein the time-continuous features are defined by a first feature vector value corresponding to a first observation time of the one or more sensors, a prediction of a steady state feature vector value, and estimated feature vector values between the first feature vector value and the steady state feature vector value, the estimated feature vector values being defined by a function.

3. The apparatus of claim 2, wherein the function is an exponential decay function or is defined by an ordinary differential equation.

4. The apparatus of claim 2, where to perform the perception task using the time-continuous features, the processing circuitry is configured to:
perform the perception task using estimated feature vector values from a time after the first observation time.

5. The apparatus of claim 1, wherein the sensor features are birds-eye-view (BEV) sensor features, and wherein to generate the sensor features from the data from the one or more sensors, the processing circuitry is configured to:
generate respective sensor features from the one or more sensors; and
generate, using the respective sensor features, a BEV representation having the BEV sensor features.

6. The apparatus of claim 5, wherein to process the sensor features with the time-continuous RNN to produce time-continuous features, the processing circuitry is configured to:
receive current BEV sensor features at a current time;
receive previous BEV sensor features from a previous time;
warp the previous BEV sensor features to a pose of the current BEV sensor features to create warped BEV sensor features;
combine the warped BEV sensor features and the current BEV sensor features to form combined BEV sensor features; and
process the combined BEV sensor features with the time-continuous RNN to form the time-continuous features.

7. The apparatus of claim 6, wherein to perform the perception task using the time-continuous features, the processing circuitry is configured to:
process the time-continuous features and the current BEV features using a transformer decoder.

8. The apparatus of claim 1, wherein the perception task includes one or more of semantic segmentation, semantic occupancy prediction, lane tracking, or 3D object detection.

9. The apparatus of claim 1, wherein the processing circuitry is further configured to:
train the time-continuous RNN using training feature vectors from non-consecutive observation times.

10. The apparatus of claim 1, wherein the one or more sensors include one or more camera sensors, one or more sonar sensors, one or more radar sensors, or one or more LiDAR sensors, and wherein to generate the sensor features from the data from the one or more sensors, the processing circuitry is configured to:
receive the data from the one or more sensors at asynchronous observation times; and
generate the sensor features from the data from the one or more sensors at each of the asynchronous observation times.

11. The apparatus of claim 1, wherein the processing circuitry is part of an advanced driver assistance system (ADAS), and wherein the ADAS is configured to control a vehicle at least in part based on an output of the perception task.

12. A method for performing a perception task, the method comprising:
generating sensor features from data from one or more sensors;
processing the sensor features with a time-continuous recurrent neural network (RNN) to produce time-continuous features; and
performing the perception task using the time-continuous features.

13. The method of claim 12, wherein the time-continuous features are defined by a first feature vector value corresponding to a first observation time of the one or more sensors, a prediction of a steady state feature vector value, and estimated feature vector values between the first feature vector value and the steady state feature vector value, the estimated feature vector values being defined by a function.

14. The method of claim 13, wherein the function is an exponential decay function or is defined by an ordinary differential equation.

15. The method of claim 13, where to performing the perception task using the time-continuous features comprises:
performing the perception task using estimated feature vector values from a time after the first observation time.

16. The method of claim 12, wherein the sensor features are birds-eye-view (BEV) sensor features, and wherein generating the sensor features from the data from the one or more sensors comprises:
generating respective sensor features from the one or more sensors; and
generate, using the respective sensor features, a BEV representation having the BEV sensor features.

17. The method of claim 16, wherein processing the sensor features with the time-continuous RNN to produce time-continuous features comprises:
receiving current BEV sensor features at a current time;
receiving previous BEV sensor features from a previous time;
warping the previous BEV sensor features to a pose of the current BEV sensor features to create warped BEV sensor features;
combining the warped BEV sensor features and the current BEV sensor features to form combined BEV sensor features; and
processing the combined BEV sensor features with the time-continuous RNN to form the time-continuous features.

18. The method of claim 17, wherein performing the perception task using the time-continuous features comprises:
processing the time-continuous features and the current BEV features using a transformer decoder.

19. The method of claim 12, further comprising:
training the time-continuous RNN using training feature vectors from non-consecutive observation times.

20. The method of claim 12, wherein the one or more sensors include one or more camera sensors, one or more sonar sensors, one or more radar sensors, or one or more LiDAR sensors, and wherein generating the sensor features from the data from the one or more sensors comprises:
receiving the data from the one or more sensors at asynchronous observation times; and
generating the sensor features from the data from the one or more sensors at each of the asynchronous observation times.
